(19) United States
(12) Patent Application Publication
(10) Pub. No.: US 2004/0015413 A1
(43) Pub. Date: Jan. 22, 2004

(54) System and method for third party facilitation of electronic payments over a network of computers

(76) Inventors: Nasser Mufid Yousef Abu-Hejleh, Gatar (GB); Khaled Mufid Yousef Hejleh, W.A. (AU)

Correspondence Address: William H Dippert, Reed Smith, 29th Floor, 599 Lexington Avenue, New York, NY, 10022, US

(21) Appl. No.: 10/433,730

(22) PCT Filed: Dec. 5, 2001
(86) PCT No.: PCT/AU01/01577

(30) Foreign Application Priority Data
Dec. 6, 2000 (AU) PR 1936

(51) Int. Cl. G06F 17/60

(52) U.S. Cl. 705/26

(57) ABSTRACT

A facilitator computer for making electronic payments. The first and second parties are a payee and a payer, who maybe a vendor (with a vendor computer) and a purchaser (with a purchaser computer). The method involves a message from the vendor computer, identifying the vendor computer and transaction details, which is received by the facilitator computer (trusted thrid party). Subsequent processing by the facilitator computer, involving interaction with the purchaser computer leads to a secure payment transaction. In coordinating the transaction, the payment server may check as to whether the customer's computer is available (on-line) and/or whether the goods or services are supplied at a timed rate. The identity of the vendor and purchaser computers is verified and authenticated against a known list of computer identities to improve security in the system.

### BACKGROUND OF THE INVENTION

A. Field of the Invention

The present invention relates generally to systems and methods for making electronic payments for goods or services and, more particularly, to systems and methods for making such payments over the Internet.

B. Description of the Related Art

Over recent years it has become increasingly common for computers to be connected to a network as part of their everyday operation. This growing ability of computers and their users to communicate with one another over networks of varying scales (from local area networks (“LANs”) to wide area networks (“WANs”) such as the Internet), coupled with the increasing use of computers as part of daily life, has created a huge market for both new and pre-existing types of goods and services to be marketed, sold, and even distributed electronically. For example, intangible goods (such as news, software or digital music) can be browsed and ordered over the Internet, then delivered electronically to the customer, while tangible items (such as books or compact discs) can also be browsed and ordered over the Internet, then delivered through conventional distribution channels.

Electronic or “e-commerce” businesses have rapidly reached a high level of scale and sophistication, to the extent that it is now possible to purchase anything from candy to nuclear fuel over the Internet. However, one of the major impediments to further growth and acceptance of e-commerce ventures, particularly those which rely on a high volume of small-scale transactions, is the fact that there is currently no accepted electronic alternative to traditional cash payments.

At present, credit cards remain the predominant method for making payments over the Internet. Customers and vendors both trust, and are familiar with credit cards as a payment method, as they are widely accepted, have been in use for many years in regular commerce, and have a well-established security and support infrastructure. Vendors typically pay credit card companies a fee for each transaction made by credit card, on the basis that, by accepting credit cards, the vendor receives more business than if it did not. However, for businesses which rely on high-volume, low-priced transactions, credit card payments become impractical due to the fees and administrative burdens attaching to each transaction. In the course of regular commerce, most companies in this position rely on cash for small transactions, but this is not possible at present for those companies which conduct business over the Internet.

A wide variety of “electronic cash” or “micro-payment” systems have been proposed to solve this problem, but none have managed to achieve widespread acceptance. Customers will not adopt a new system until it is widely accepted and proven, yet vendors will not adopt a new system until there is a strong customer demand-creating a “chicken and the egg” problem. Customers will not support a system until a wide range of vendors support it, yet the vendors will not support it until the customers want it.

Different providers of goods and services over the Internet will often each support different proprietary systems for authenticating the creditworthiness of customers and securing payment for goods and services supplied. The resulting inconvenience to customers is that they are required to submit their personal details and credit information to a different entity each time they seek to purchase goods or services from a different provider over the Internet. Given widespread public-concerns about the privacy and security of the Internet, the less often customers are required to disclose their personal details and credit information, the easier it is to build customer confidence in the security and convenience of electronic commerce.

Due to the nature of communication over the Internet, most messages are routed through a number of intermediary computers before they reach their destination. It is possible in theory for these messages to be intercepted and even decrypted (if they have been encrypted for security reasons). While such interception is difficult in practice, it is nonetheless desirable to minimise the amount of sensitive information being transmitted from one computer to another.

Large numbers of potential on-line sales are lost because of the reluctance of customers to register their personal details and provide credit information to yet another vendor, with the potential for that information to be intercepted, stolen, sold or otherwise misused. The simpler and less obtrusive the payment system, the greater the likelihood that customers will make a purchase.

For the growing number of businesses conducted entirely over the Internet, this is an issue of paramount importance.

The object of the invention is to provide a new method and system by which small payments may be made over the Internet using means which customers already trust and are familiar with.

### SUMMARY OF THE INVENTION

According to the present invention in a first aspect, there is provided a method to enable a facilitator computer to facilitate payment for goods and/or services in a transaction between a vendor and a purchaser, wherein the facilitator computer, a vendor computer (associated with said vendor), and a purchaser computer (associated with said purchaser) are connectable to a computer network, and wherein the purchaser computer is connectable to said network via an access provider with which the purchaser has established a network access service account, the method comprising the steps of receiving, for the transaction, a message from said vendor computer identifying the vendor computer, the purchaser computer, and details regarding the transaction, comparing the identities of the vendor computer and the purchaser computer with stored identities for known vendor computers and purchaser computers, in response to a failure to match either the vendor computer or the purchaser computer identities with said stored identities, optionally terminating the transaction, in response to a match for both the vendor computer and the purchaser computer identities with said stored identities, retrieving details of the purchaser computer from stored details, sending a message to said purchaser computer seeking purchaser confirmation that the details of the transaction specified in the message received from the vendor computer are correct and that the purchaser is prepared to pay for the goods and/or services, in response to a failure to receive purchaser confirmation, sending a message to the vendor computer instructing it to terminate the transaction, in response to receipt of purchaser confirmation, sending a message to the vendor computer instructing it to provide the goods and/or services to the purchaser and recording details of the transaction, and sending at least some of said transaction details to said access provider for addition to said network access service account.

The computer network may be the Internet, or alternatively may be a local area network

The purchaser computer and the vendor computer may be two separate processing applications operating on the same computer.

In one form of the invention, said transaction is in respect of services or products provided by said vendor computer to said purchaser computer, the cost of said services or products being provided by the vendor computer to the purchaser computer based on the amount of time for which said services or products are provided.

In this particular form of the invention, the facilitator computer may determine the amount of time for which said services or products are provided by sending monitoring messages to said purchaser computer, receiving a response termination message from die purchaser computer, whereupon the service or product provision is discontinued.

Said monitoring messages may include timing information for display to said purchaser, enabling the purchaser to selectively send a termination message.

In a preferred form, from the moment the vendor computer commences the supply of services or products, said monitoring messages are sent to said purchaser computer and return messages are received in response to said monitoring messages, the duration of service provision determined according to the time until a response message is not received from the purchaser computer.

Preferably, for each transaction, a unique session code is established and provided to said purchaser computer, and once a termination message is received from the purchaser computer, said unique session code is designated as invalid.

According to the present invention in a second aspect, there is provided a method by which an access provider enables payment, by a purchaser, for goods and/or services purchased over a computer network from at least one vendor associated with at least one respective vendor computer, comprising the steps of providing a purchaser computer associated with said purchaser with access to the network, receiving messages from a facilitator computer operating in accordance with any preceding claim, the messages containing details of goods and/or services purchased by said purchaser over the network, adding details, including price details of said goods and/or services, to a bill sent by the access provider to the purchaser, receiving payment from the purchaser in response to said bill, and remitting payment (directly or indirectly via said facilitator computer) to said at least one vendor for said goods and/or services.

According to the present invention in a third aspect, there is provided a method of using a purchaser computer to enable a purchaser to pay a vendor for goods and/or services, by making use of a computer network to which the purchaser computer and a vendor computer (associated with the vendor) are connectable, the method involving the intermediary of a facilitator computer connectable to the network and arranged to facilitate payment for goods and/or services over the network, the method comprising the steps of connecting with the network via a network access provider, sending, to the facilitator computer, a message containing a network address of a purchaser computer associated with said purchaser and an identification code to identify the purchaser or the user of the purchaser computer, receiving notification of successful verification of said purchaser computer network address and said identification code by said facilitator computer, selecting goods and/or services offered by way of the vendor computer and sending a request to purchase those goods and/or services, receiving a message from the facilitator computer containing details of said goods and/or services, sending a confirmation message to the facilitator computer confirming willingness to purchase the goods and/or services from the vendor, receiving the goods and/or services from the vendor, and paying the network access provider for the goods and/or services received from the vendor as part of an account payment for network access.

Preferably, the above-defined method in respect of purchase of services or products includes the steps of receiving a session code from said facilitator computer, the session code signifying successful verification of said purchaser computer network address and said identification code by said facilitator computer, receiving monitoring messages sent by the facilitator computer, and sending a return response termination message to the facilitator computer, wherein the payment for the services or products is made in accordance with the length of time of receipt of the services as determined by the facilitator computer.

Preferably, the method includes the step of displaying to the purchaser, in response to said monitoring messages, time metering information, and enabling the purchaser to selectively send a termination message to said facilitator computer.

In response to the monitoring messages, return response messages may be sent to the facilitator computer, to enable determination by the facilitator computer as to a network connection status of the purchaser computer network connection, in order to determine service or product provision duration.

According to the present invention in a fourth aspect, there is provided a computer-based system for enabling a facilitator computer to facilitate payment for goods and/or services in a transaction between a vendor and a purchaser, wherein the facilitator computer, a vendor computer (associated with said vendor), and a purchaser computer (associated with said purchaser) are connectable to a computer network, and wherein the purchaser computer is connectable to said network via an access provider with which the purchaser has established a network access service account, the system including means for receiving, for the transaction, a message from said vendor computer identifying the vendor computer, the purchaser computer, and details regarding the transaction, means for comparing the identities of the vendor computer and the purchaser computer with stored identities for known vendor computers and purchaser computers, means for, in response to a failure to match either the vendor computer or the purchaser computer identities with said stored identities, optionally terminating the transaction, means for, in response to a match for both the vendor computer and the purchaser computer identities with said stored identities, retrieving details of the purchaser computer from stored details, means for sending a message to said purchaser computer seeking purchaser confirmation that the details of tie transaction specified in the message received from the vendor computer are correct and that the purchaser is prepared to pay for the goods and/or services, means for, in response to a failure to receive purchaser confirmation, sending a message to the vendor computer instructing it to terminate the transaction, means for, in response to receipt of purchaser confirmation, sending a message to the vendor computer instructing it to provide the goods and/or services to the purchaser and recording details of the transaction, and means for sending at least some of said transaction details to said access provider for addition to said network access service account.

When said transaction is in respect of services or products provided by said vendor computer to said purchaser computer, tie cost of said services may be provided by the vendor computer to the purchaser computer based on the amount of time for which said services or products are provided.

To this end, the facilitator computer may include a metering module to determine the amount of time for which said services or products are provided, said metering module arranged to send monitoring messages to said purchaser computer at regular intervals, and receive return messages in response to said monitoring messages from the moment that the vendor computer commences the supply of services or products until the moment that a response message is not received from the purchaser computer, or a termination message is received by the facilitator computer.

According to the present invention in a fifth aspect, there is provided a computer-based system for using a purchaser computer to enable a purchaser to pay a vendor for goods and/or services, by making use of a computer network to which the purchaser computer and a vendor computer (associated with the vendor) are connectable, involving the intermediary of a facilitator computer connectable to the network and arranged to facilitate payment for goods and/or services over the network, the system including means for connecting with the network via a network access provider, means for sending, to the facilitator computer, a message containing a network address of a purchaser computer associated with said purchaser and an identification code to identify the purchaser or the user of the purchaser computer, means for receiving notification of successful verification of said purchaser computer network address and said identification code by said facilitator computer, means for selecting goods and/or services offered by way of the vendor computer and sending a request to purchase those goods and/or services, means for receiving a message from the facilitator computer containing details of said goods and/or services, means for sending a confirmation message to the facilitator computer confirming willingness to purchase the goods and/or services from the vendor, means for receiving the goods and/or services from the vendor, and means for paying the network access provider for the goods and/or services received from the vendor as part of an account payment for network access.

For use in purchase of services or products, the system may include means for receiving a session code from said facilitator computer, the session code signifying successful verification of said purchaser computer network address and said identification code by said facilitator computer, means for receiving monitoring messages sent by the facilitator computer, and for sending a return response termination message to the facilitator computer, wherein the payment for the services or products is made in accordance with the length of time of receipt of the services or products as determined by the facilitator computer.

The system preferably includes means to display, in response to said monitoring messages, time metering information, and means for enabling the purchaser to selectively send a termination message to the facilitator computer.

In this form of the invention, the system preferably includes means for sending return response messages to the facilitator computer in response to receipt of said monitoring messages, to enable determination by the facilitator computer as to a network connection status of the purchaser computer, in order to determine service or product provision duration.

Methods, systems, and articles of manufacture consistent with the present invention therefore provide a transparent and secure means for facilitating payment for goods and services over the Internet using a third-party payment server (the facilitator computer) to coordinate, authenticate and record transactions between the vendor computer and the customer computer. The third-party payment server, if present in the system is distinct from the customer's computer network access provider.

In one form of the invention, then, the vendor computer notifies the payment server when a customer has requested to purchase goods or services using the payment system provided by the payment server. The payment server then contacts the customer computer with details of the intended transaction, and asks the customer computer to confirm that it will pay for the goods or services to be provided. If the customer computer does not confirm that it will pay for the transaction, the payment server sends a denial message to the vendor computer, which terminates the transaction with the customer computer. If the customer computer does confirm that it will pay for the transaction, the payment server sends a confirmation message to the vendor computer, which proceeds to supply the specified goods or services to the customer computer. If the goods or services are fixed price, one-off items, then the charge incurred by the customer computer in purchasing those goods or services is simply recorded by the payment server after the customer computer accepts the transaction. Preferably, if tie goods or services are supplied at a timed rate, then as soon as the customer computer confirms that it will pay for the goods or services, the payment server establishes a separate secure channel to the customer computer, and regularly polls the customer computer to determine whether it is still available (and therefore still confirming outgoing payment for the goods or services). The vendor computer continues to provide the timed goods or services until it is notified by the payment server that the customer computer is no longer available or has otherwise ended the transaction. The cost of the goods or services received by the customer computer is then calculated and recorded by the payment server based on the length of time for which the customer received the goods or services, and the specified rate per unit of time. The vendor computer and the customer computer may be one and the same in certain embodiments of the present invention such as when the user of a computer wishes to use an installed software application that is only available on a pay-per-use basis.

At periodic intervals, the payment server may send details of charges incurred by the customer computer to that customer computer's network access provider, and those charges are added to the customer computer's regular bill for network access.

### BRIEF DESCRIPTION OF THE DRAWINGS

The accompanying drawings, which are incorporated in and constitute a part of this specification, illustrate a non-limiting implementation of the invention and, together with the description, serve to explain the advantages and principles of the invention. In the drawings:

FIG. 1 is an illustration of a computer network for practising methods and systems consistent with the present invention;

FIG. 2 is a diagram setting out the steps that the user of a remote computer must perform when they first participate as a customer in-the system described by the present invention;

FIG. 3 is a diagram setting out the steps performed each time the user of a remote computer is connected to a communications network and wishes to make use of the payment system described by the present invention;

FIG. 4 is a diagram illustrating the communications between a payment server, an access provider, a remote computer acting as customer and a remote computer acting as a vendor where the customer pays for goods or services provided by the vendor in a manner consistent with the present invention.

FIG. 5 is a diagram setting out the steps performed when the user of a remote computer pays for the use of a processing application installed on that remote computer by using a payment system consistent with the present invention.

### DETAILED DESCRIPTION

The following detailed description of the invention refers to the accompanying drawings. Although the description includes exemplary implementations, other implementations are possible, and changes may be made to the implementations described without departing from the spirit and the scope of the invention. The following detailed description does not therefore limit the invention. Wherever possible, the same reference numbers will be used throughout the drawings and the following description to refer to the same or like parts.

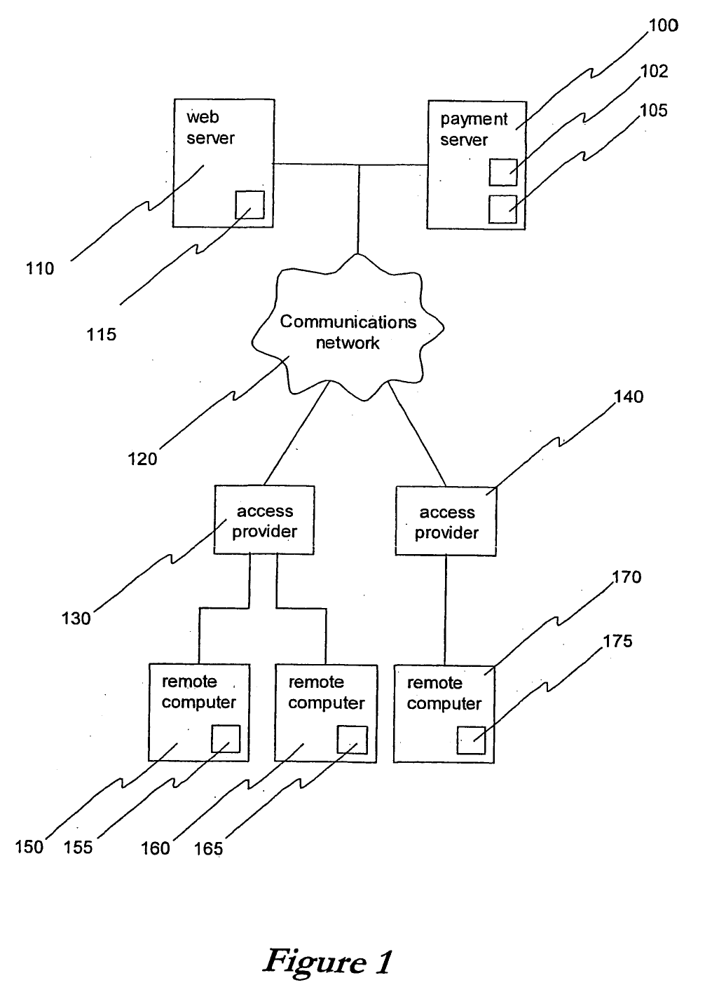

The system includes a remote computer that seeks to purchase goods or services from another remote computer, using a third-party payment server to facilitate payment for those goods or services. Both remote computers communicate with one another, and with the payment server, via a communications network. The remote computers and the payment server may be connected directly to the communications network, or be connected via an access provider. That basic arrangement is shown in FIG. 1.

The computer network includes a payment server 100, a web server 110, a communications network 120, one or more access providers 130 and 140, and one or more remote computers 150, 160 and 170. All of the computers in FIG. 1 are connected, either directly or indirectly, continually or intermittently, via a communications network 120. In FIG. 1, remote computers 150 and 160 are connected to communications network 120 via access provider 130, and remote computer 170 is connected to communications network 120 via access provider 140.

In one embodiment, the communications network 120 is the Internet, a Transmission Control Protocol/Internet Protocol (“TCP/IP”) wide-area network, and the computers are connected to communications network 120 using technology in common use. For example, remote computer 150 may be connected to access provider 130 using a modern connected to a telephone line, or via a network interface card connected to a local area network. Access provider 130 may in turn be connected to communications network 120 using a point-to-point dedicated network connection such as a T3 line, or any other technology-in common use.

In other embodiments of the present invention, communications network 120 is any device that allows the computers to communicate with each other. For example, communications network 120 can be a local area network, an Intranet, dedicated point-to-point communication lines, or a wireless transmission network. Further, communications network 120 might take a different form for different pairs of computers. For example, payment server 100 might communicate to access provider 130 via the Internet, and access provider 130 might communicate to access provider 140 via a local area network.

In one embodiment of the present invention, a remote computer 150 desires to purchase goods or services offered by remote computer 170 using the payment system facilitated by payment server 100. In another embodiment, the customer computer and vendor computer may be connected to the same access provider, for example remote computers 150 and 160, both of which are connected to access provider 130. In yet another embodiment, one remote computer may act as both a customer and a vendor to other remote computers.

The functionality of the steps performed by payment server 100 and customer computer 150 as part of the present invention is included in processing applications 102 and 155, which are stored on, and executed by payment server 100 and remote computer 150 respectively. The processing applications may be stored in memory, for example a hard drive, associated with each computer. The computer in question loads the processing application into its associated memory, for example its RAM, for executing the processing application. Although aspects of the present invention are described as being stored in memory, one skilled in the art will appreciate that these aspects may be stored on or read from other-computer-readable media, such as secondary storage devices, like hard disks, floppy disks, and CD-ROM; a carrier wave received from a network like the Internet; or other forms of ROM or RAM.

In a preferred embodiment of the present invention, processing application 102 comprises a number of servlets (typically written in the Java programming language) that are portable between different servers and operating systems, whereas processing application 155 may typically be written in the C programming language with versions available for a number of different operating systems, including Microsoft Windows, MacOS, Linux and UNIX.

Stored on payment server 100, or on a computer or storage device associated with payment server 100, is a database 105, or a plurality of databases which store information relating to the users of the payment system facilitated by payment server 100 and information about each transaction conducted using that system.

In a preferred embodiment of the present invention, the databases associated with payment server 100 ate constructed using a database management system that supports Structured Query Language (“SQL”) for queries and data processing.

In one embodiment of the present invention, processing application 155 is downloaded from web server 110 and installed on customer computer 150. In another embodiment of the present invention, the functionality of the steps performed by customer computer 150 may be provided by instructions incorporated into the programming code of a larger processing application installed on the customer computer.

The functionality of the steps performed by vendor computer 170 as part of the present invention does not require a separate processing application. Instead it relies on a series of special instructions 175 incorporated into the programming code underlying the Internet site from which vendor computer 170 offers goods or services for sale. These instructions invoke the necessary functionality of customer computer 150 and payment server 100 in response to a purchase request from customer computer 150. Details of the programming code necessary to make a vendor site compatible with the system of the present invention will be freely available to help ensure widespread support for the system.

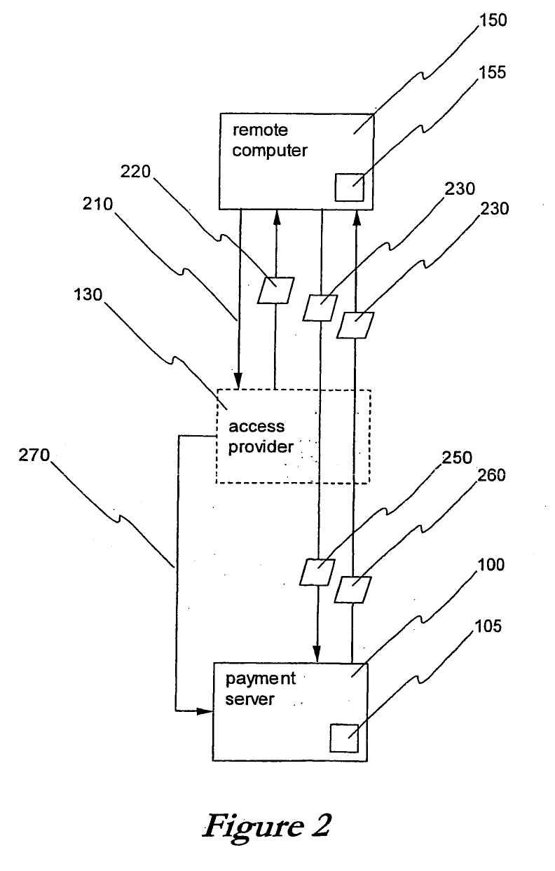

FIG. 2 is a diagram setting out the steps that the user of remote computer 150 must perform when they first participate as a customer in the 'system described by the present invention.

A compatible processing application 155 must first be installed on remote computer 150 to give it the required functionality. In a preferred embodiment of the present invention, the processing application 155 will be downloaded from a web server (not shown) associated with the payment server 100.

In another embodiment of the present invention, the processing application 155 may be incorporated into the programming code of a larger processing application installed on remote computer 150.

When executed, the processing application first determines the unique network address of the remote computer on which it is executing. In a preferred embodiment of die present invention, this network address will be the Internet Protocol (“IP”) address of the remote computer, which is a unique 32-bit numeric identifier used on TCP/IP networks. As there is a finite number of IP addresses, access providers will typically each have a pool of registered IP addresses, which they will dynamically allocate to users each time a network session is initiated. However, some users may have their own registered ‘static’ IP address.

Under the present invention, the registered holder of an IP address should be the only person who can register that IP address as being able to participate in the payment system offered by payment server 100. In most cases, that person will be the access:provider.

In the example shown in FIG. 2, remote computer 150 sends a message 210 to access provider 130, requesting a network connection. Access provider 130 facilitates the connection of remote computer 150 to a communications network, and allocates a network address 220 to remote computer 150 for the duration of the session.

Once the processing application 155 has determined the network address of remote computer 150 for that session, it sends a query 230 in respect of that network address to the database 105 maintained by payment server 100. If the remote computer's network address has not been registered in the payment server's database, then the processing application prompts the user of the remote computer to contact their access provider to arrange such registration. If the network address of remote computer 150 is registered in the database 105 of payment server 100, then payment server 100 sends a message 240 to the remote computer 150 confirming that fact, and the processing application prompts the user of remote computer 150 to enter their unique identification code. In a preferred embodiment of the present invention, that unique identification code comprises a user name and a password. Once entered, the user's unique identification code is then encrypted and transmitted 250 to the payment server 100, which creates a new entry in its database 105 corresponding with the user of remote computer 150.

In a currently preferred implementation of the invention, processing application 155 sends to payment server 100 the domain name and username from remote computer 150. Server 100 detects the IP address from the connection. The server verifies the username, domain name and IP address as a single verification step. If that is not a new user, server 100 then requests and verifies the user's password. If this is a new user but the IP address and domain name are registered, the server emails an initial password to the user. If the domain is not registered, the client application 155 prompts the user to contact his or her access provider.

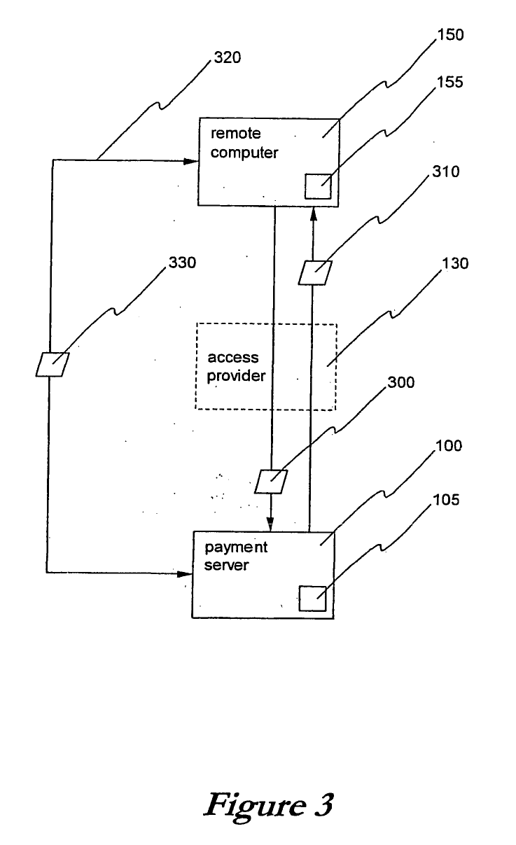

FIG. 3 is a diagram setting out the steps performed each time the user of remote computer 150 is connected to communications network 120 and wishes to make use of the payment system described by the present invention, assuming that the user of remote computer 150 is already registered with payment server 100 as a participating customer.

First, the processing application 155 is executed and the user's unique identification code 300 is entered and transmitted to payment server 100, which then queries its database 105. If the user's unique identification code 300 is valid, the payment server 100 issues remote computer 150 with a unique session code 310 which is stored in the memory of remote computer 150. Upon issuing session code 310, payment server 100 also establishes a separate secure channel 320 between remote computer 150 and itself. At periodic intervals, payment server 100 sends a message 330 to remote computer 150 using channel 320. If payment server 100 does not receive a response from remote computer 150 to periodic message 330 within a predetermined time, then payment server 100 deems remote computer 150 to be unavailable and terminates the session. The session is also terminated if the user of remote computer 150 sends a specific request to payment server 100 to terminate the session.

In a preferred embodiment of the present invention, the periodic message 330 sent from payment server 100 to remote computer 150 is a packet sent to the IP address of remote computer 150 by a Packet Internet Groper (“ping”) utility executing on payment server 100.

Alternatively, the request messages 330 and response acknowledgement messages are sent over the already established secure channel connection with remote computer 150, and these messages can contain additional customised information.

Once the session is terminated, the session code 320 issued to remote computer 150 ceases to be valid, and the payment system described by the present invention cannot be used by remote computer 150 until the user of that computer starts a new session with payment server 100 and is issued a new session code.

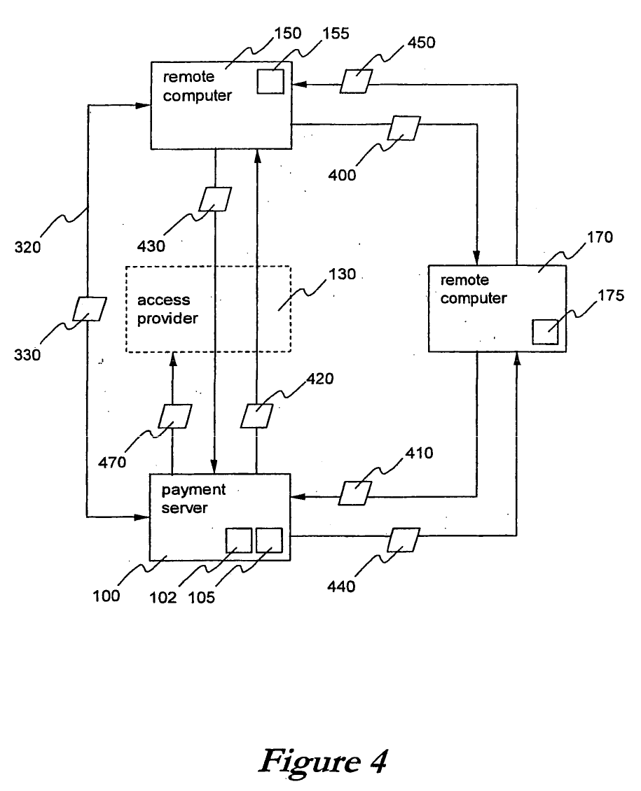

FIG. 4 is a diagram setting out the steps performed when the user of remote computer 150 seeks to purchase goods or services from remote computer 170 using the payment system described by the present invention.

The user of remote computer 150 starts a session with payment server 100 by sending their unique identification code to payment server 100, which checks whether the user's identification code and the network address of remote computer 150 are valid. If the validity of the user's identification code and the network address of remote computer 150 are confirmed, then payment server 100 sends a unique session code to remote computer 150 and establishes a channel 320 between itself and remote computer 150.

Using technology in common use, including Internet browser software such as Microsoft Internet Explorer™, Netscape Navigator™, or NCSA Mosaic™, the user of remote computer 150 retrieves information over a communications network about goods or services offered by remote computer 170. Remote computer 170 provides functionality which allows customers to purchase goods or services electronically over a communications network. The programming code which provides remote computer 170 with this on-line purchasing functionality includes programming instructions which call certain functions on processing applications stored on payment server 100 and remote computer 150 in the event that the user of remote computer 150 elects to pay for goods or services using the payment system described by the present invention.

If the user of remote computer 150 wishes to purchase goods or services offered by remote computer 170 using the payment method facilitated by payment server 100, then remote computer 150 sends a message 400 to remote computer 170 which identifies the goods or services it wishes to purchase. Message 400 also includes the unique session code issued to remote computer 150 by payment server 100. Message 400 can be generated by populating and submitting an HTML form on the vendor's website, for example.

Upon receiving message 400 from remote computer 150, remote computer 170 sends a message 410 to payment server 100. The purpose of message 410 is to determine whether the user of remote computer 150 can and will pay for the goods or services it has requested. Message 410 includes details of the goods or services which remote computer 150 seeks to purchase, as well as the unique session code issued to remote computer 150 by payment server 100. The message may also include the network address of remote computer 150.

Payment server 100 determines whether the network address from which remote computer 170 received the purchase request corresponds with the network address to which the unique session code was issued. If the network address and session code match, then payment server 100 sends a message 420 to remote computer 150, requesting. confirmation from the user of remote computer 150 that they are prepared to pay for the specified goods or services. The message 420 sent to remote computer 150 includes details of the goods or services that are the subject of the requested purchase, and details of the fixed cost or rate (in the case of timed goods or services) to be charged. Processing application 155 on remote computer 150 displays the details of the goods or services and the associated cost and requests confirmation from the user If these details are confirmed by the user, a confirmation message 430 is sent from remote computer 150 to payment server 100, which records the user's confirmation, the time at which confirmation was received, a description of the goods or services involved, and the rate at which those goods or services are to be charged. A further confirmation message 440 is sent from payment server 100 to remote computer 170. Message 440 confirms to remote computer 170 that the user of remote computer 156 has agreed to pay for the specified goods or services, and is able to do so.

In a preferred embodiment of the present invention, the time used by the payment server 100 for the purpose of recording details about each transaction and, where appropriate, the duration of the transaction, will be uniform throughout tie world, and will be the time in use at the geographical location of the payment server.

After receiving confirmation message 440, remote computer 170 proceeds to provide the requested goods or services 450 to the user of remote computer 150. Those goods or services 450 may be provided immediately to the user of remote computer 150 using electronic means if the goods or services are intangible in nature, such as pay-per-view movies or digitally encoded music. If the goods or services 450 are tangible in nature, such as books or compact discs, then remote computer 170 may dispatch those goods or provide those services using conventional delivery methods such as the postal service.

In the case of goods or services for which the cost is determined based on the amount of time the user spends viewing or using them, a feedback system is used to determine the length of time for which the user is charged. Goods falling within this category would include on-line movies for which users pay depending on how long they watch. Services falling within this category would include on-line processing applications or news information services.

When the user of remote computer 150 requests to view a movie offered by remote computer 170, for example, then remote computer 170 would send a message 410 to payment server 100 as detailed above, requesting confirmation of whether the user of remote computer 150 can and will pay for the requested movie. Instead of specifying a fixed price to be charged to the user's account, the cost of viewing the movie could instead be set, for example, at 50 cents per minute.

When payment server 100 receives confirmation 430 from the user of remote computer 150 that they agree to pay for goods or services that are charged on a timed basis, a confirmation message 440 is sent to remote computer 170 which begins providing the goods or services 450. Payment server 100 also shortens the intervals between the messages 330 that ate sent to remote computer 150 along channel 320, giving a more accurate and timely indication of whether remote computer 150 is still available to receive the goods or services. If a response to each message 330 is not received within a predetermined period of time, payment server 100 deems remote computer 150 to be no longer available, and sends a message to remote computer 170 instructing it to cease providing the timed goods or services to remote computer 150. Similarly, if payment server 100 receives a message from remote computer 150 that it wishes to discontinue paying for the goods or services, payment server 100 sends a message to remote computer 170 instructing it to cease providing the timed goods or services to remote computer 150.

Remote computer 170 may be configured to block unsolicited messages such as those sent from payment server 100. In this case, remote computer 170 periodically sends a query message to server 100 to determine the status of the purchaser.

In this respect, the remote computer 150 is configured to display a real-time time or charge meter to the customer, along with a <STOP> button, to enable the customer to monitor his or her charge liability and to selectively and reliably terminate the service as desired. This may be important in many practical situations, where a clear real-time indication to the user of charges incurred is required to encourage consumer confidence in the system.

The vendor (remote computer 170) can also terminate the timed session by sending a message to server 100, which in turn sends a termination message to remote computer 150. This may be used if the purchaser clicks an <EXIT> link on the vendor's website, for example.

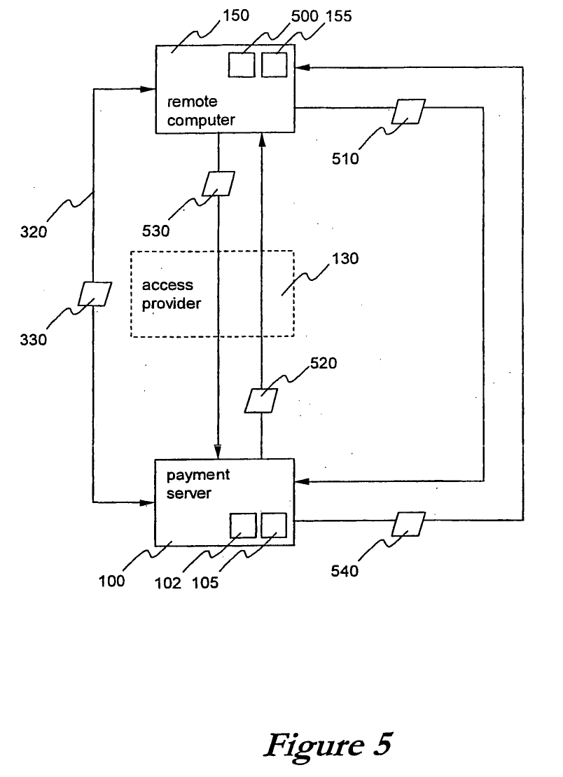

FIG. 5 is a diagram setting out the steps performed when the user of remote computer 150 seeks to use processing application 500, which is installed on remote computer 150 and which supports the payment system described by the present invention.

In this embodiment of the present invention, instead of purchasing goods or services electronically from another remote computer over a communications network, the user of remote computer 150 pays for the use of a processing application that is installed on remote computer 150.

For example, software is often distributed on a “shareware” basis, by which it is made available free of charge in the hope that users will pay for it voluntarily if they find it useful, or will purchase commercial upgrades which add extra functionality. This revenue model and method of distribution could become more viable if functionality was written into the programming code of the shareware software which required payments to be made to the software developer. The requirement for payment could be triggered after a predetermined period of free use, or could be used to unlock added functionality within the software. Failure to make the required payment may disable the software, or restrict its functionality. Similar payment schemes using the present invention could also be incorporated into commercial software, for example, as a means for collecting regular licence fees.

If the user of remote computer 150 seeks to use processing application 500, and wishes to pay for it using the payment method facilitated by payment server 100, then processing application 500 sends a message 510 to payment server 100. The purpose of message 510 is to determine whether the user of remote computer 150 can, and will pay for the use of processing application 500. Message 510 includes, at least, details of the processing application which remote computer 150 seeks to use, and the unique session code issued to remote computer 150 by payment server 100.

Payment server 100 determines whether the network address of the computer requesting use of processing application 500 corresponds with the network address to which the unique session code was issued. If the network address and session code match, then payment server 100 sends a message 520 to processing application 155 on remote computer 150, requesting confirmation from the user of remote computer 150 that they are prepared to pay for the use of processing application 500. The message 520 sent to remote computer 150 includes details of the processing application that is the subject of the requested purchase, and details of the fixed cost or rate (in the case of timed use) to be charged.

Processing application 155 on remote computer 150 displays the details of processing application 500 along with the associated cost of use, and requests confirmation from the user. If these details are confirmed by the user, a confirmation message 530 is sent from remote computer 150 to payment server 100, which records the user's confirmation, the time at which confirmation was received, a description of the processing application involved, and the rate at which use of that processing application is to be charged. A further confirmation message 540 is sent from payment server 100 to processing application 500 on remote computer 150. Message 440 confirms to processing application 500 that the user of remote computer 150 has agreed to pay for use of that application, and is able to do so.

In one embodiment of the present invention, the functionality of processing application 155 may be incorporated into the programming code of processing application 500. In another embodiment of the present invention, processing application 155 and processing application 500 may be discrete applications.

After receiving confirmation message 440, processing application 500 allows the user of remote computer 150 to access and use its functionality, or to access and use certain added functionality within that processing application as the case may be.

In cases where the use of processing application 500 is to be charged at a timed rate, a feedback system is used to determine the length of time for which the user is charged, as described above in the context of pay-per-view movies for example.

At periodic intervals, payment. server 100 sends to access provider 130 details of all the costs incurred by the user of remote computer 150. Those details and costs are then added to the regular bill sent from access provider 130 to the user of remote computer 150. When the bill is paid, a portion of the payment is passed on to an account associated with payment server 100, from which the provider of the goods or services is reimbursed.

In a preferred embodiment of the present invention, access provider 130 is the Internet service provider (“ISP”) for remote computer 150, and the payments made by remote computer 150 using the system provided by payment server 100 are added to the ISP's regular bill to the user of remote computer 150. When the user of remote computer 150 pays their ISP bill the ISP pays to an account associated with payment server 100 the amount due to remote computer 170 for the provision of goods or services, and that amount is then paid to an account associated with, or nominated by remote computer 170.

The foregoing description of an implementation of the invention has been presented for purposes of illustration and description. It is not exhaustive and does not limit the invention to the precise form disclosed. Modifications and improvements to the invention will be readily apparent to those skilled in the art. Such modification and improvements are intended to be within the scope of this invention.

The word “comprising” and forms of the word “comprising” as used in this description does not limit the invention claimed to exclude any variants or additions.

1. A method to enable a facilitator computer to facilitate payment for goods and/or services in a transaction between a vendor and a purchaser, wherein the facilitator computer, a vendor computer (associated with said vendor), and a purchaser computer (associated with said purchaser) are connectable to a computer network, and wherein the purchaser computer is connectable to said network via an access provider with which the purchaser has established a network access service account, the method comprising the steps of.
receiving, for the transaction, a message from said vendor computer identifying the vendor computer, the purchaser computer, and details regarding the transaction;
comparing the identities of the vendor computer and the purchaser computer with stored identities for known vendor computers and purchaser computers;
in response to a failure to match either the vendor computer or the purchaser computer identities with said stored identities, optionally terminating the transaction;
in response to a match for both the vendor computer and the purchaser computer identities with-said stored identities, retrieving details of the purchaser computer from stored details;
sending a message to said purchaser computer seeking purchaser confirmation that the details of the transaction specified in the message received from the vendor computer are correct and that the purchaser is prepared to pay for the goods and/or services;
in response to a failure to receive purchaser confirmation, sending a message to the vendor computer instructing it to terminate the transaction;
in response to receipt of purchaser confirmation, sending a message to the vendor computer instructing it to provide the goods and/or services to the purchaser and recording details of the transaction; and
sending at least some of said transaction details to said access provider for addition to said network access service account.

2. The method of claim 1, wherein the network is the Internet.

3. The method of claim 1, wherein the network is a local area network.

4. The method of any preceding claim, wherein the purchaser computer and the vendor computer are two separate processing applications operating on the same computer.

5. The method of any preceding claim, wherein said transaction is in respect of services or products provided by said vendor computer to said purchaser computer, the cost of said services or products being provided by the vendor computer to the purchaser computer based on the amount of time for which said services or products are provided.

6. The method of claim 5, wherein said facilitator computer determines the amount of time for which said services or products are provided by sending monitoring messages to said purchaser computer, receiving a response termination message from the purchaser computer, whereupon the service or product provision is discontinued.

7. The method of claim 6, wherein said monitoring messages include timing information for display to said purchaser, enabling the purchaser to selectively send a termination message.

8. The method of claim 6, wherein, from the moment the vendor computer commences the supply of services or products, said monitoring messages are sent to said purchaser computer and return messages are received in response to said monitoring messages, the duration of service provision determined according to the time until a response message is not received from the purchaser computer.

9. The method of any preceding claim, wherein, for each transaction, a unique session code is established and provided to said purchaser computer, and once a termination message is received from the purchaser computer, said unique session code is designated as invalid.

10. A method by which an access provider enables payment, by a purchaser, for goods and/or services purchased over a computer network from at least one vendor associated with at least one respective vendor computer, comprising the steps of:
providing a purchaser computer associated with said purchaser with access to the network;
receiving messages from a facilitator computer operating in accordance with any preceding claim, the messages containing details of goods and/or services purchased by said purchaser over the network;
adding details, including price details of said goods and/or services, to a bill sent by the access provider to the purchaser;
receiving payment from the purchaser in response to said bill; and
remitting payment (directly or indirectly via said facilitator computer) to said at least one vendor for said goods and/or services.

11. A method of using a purchaser computer to enable a purchaser to pay a vendor for goods and/or services, by making use of a computer network to which the purchaser computer and a vendor computer (associated with the vendor) are connectable, the method involving the intermediary of a facilitator computer connectable to the network and arranged to facilitate payment for goods and/or services over the network, the method comprising the steps of:
connecting with the network via a network access provider;
sending, to the facilitator computer, a message containing a network address of a purchaser computer associated with said purchaser and an identification code to identify the purchaser or the user of the purchaser computer;
receiving notification of successful verification of said purchaser computer network address and said identification code by said facilitator computer;
selecting goods and/or services offered by way of the vendor computer and sending a request to purchase those goods and/or services;
receiving a message from the facilitator computer containing details of said goods and/or services;
sending a confirmation message to the facilitator computer confirming willingness to purchase the goods and/or services from the vendor;
receiving the goods and/or services from the vendor; and
paying the network access provider for the goods and/or services received from the vendor as part of an account payment for network access.

12. A method according to claim 11 in respect of purchase of services or products, including the steps of:
receiving a session code from said facilitator computer, the session code signifying successful verification of said purchaser computer network address and said identification code by said facilitator computer;
receiving monitoring messages sent by the facilitator computer, and sending a return response termination message to the facilitator computer;
wherein the payment for the services or products is made in accordance with the length of tine of receipt of the services or products as determined by the facilitator computer.

13. The method of claim 12, including the step of displaying to the purchaser, in response to said monitoring messages, time metering information, and enabling the purchaser to selectively send a termination message to said facilitator computer.

14. The method of claim 12 wherein, in response to said monitoring messages, return response messages are sent to the facilitator computer, to enable determination by the facilitator computer as to a network connection status of the purchaser computer network connection, in order to determine service or product provision duration.

15. A computer-based system for enabling a facilitator computer to facilitate payment for goods and/or services in a transaction between a vendor and a purchaser, wherein the facilitator computer, a vendor computer (associated with said vendor), and a purchaser computer (associated with said purchaser) are connectable to a computer network, and wherein the purchaser computer is connectable to said network via an access provider with which the purchaser has established a network access service account, the system including:
means for receiving, for the transaction, a message from said vendor computer identifying the vendor computer, the purchaser computer, and details regarding the transaction;
means for comparing the identities of the vendor computer and the purchaser computer with stored identities for known vendor computers and purchaser computers;
means for, in response to a failure to match either the vendor computer or the purchaser computer identities with said stored identities, optionally terminating the transaction;
means for, in response to a match for both the vendor computer and the purchaser computer identities with said stored identities, retrieving details of the purchaser computer from stored details;
means for sending a message to said purchaser computer seeking purchaser confirmation that the details of the transaction specified in the message received from the vendor computer are correct and that the purchaser is prepared to pay for the goods and/or services;
means for, in response to a failure to receive purchaser confirmation, sending a message to the vendor computer instructing it to terminate the transaction;
means for, in response to receipt of purchaser confirmation, sending a message to the vendor computer instructing it to provide the goods and/or services to tie purchaser and recording details of the transaction; and
means for sending at least some of said transaction details to said access provider for addition to said network access service account.

16. The system of claim 15, wherein said transaction is in respect of services or products provided by said vendor computer to said purchaser computer, the cost of said services being provided by the vendor computer to tie purchaser computer based on the amount of time for which said services or products are provided.

17. The system of claim 16, the facilitator computer including a metering module to determine the amount of time for which said services or products are provided, said metering module arranged to send monitoring messages to said purchaser computer at regular intervals, and receive return messages in response to said monitoring messages from the moment that the vendor computer commences the supply of services or products until the moment that a response message is not received from the purchaser computer, or a termination message is received by the facilitator computer.

18. A computer-based system for using a purchaser computer to enable a purchaser to pay a vendor for goods and/or services, by making use of a computer network to which the purchaser computer and a vendor computer (associated with the vendor) are connectable, involving the intermediary of a facilitator computer connectable to the network and arranged to facilitate payment for goods and/or services over the network, the system including:
means for connecting with the network via a network access provider;
means for sending, to the facilitator computer, a message containing a network address of a purchaser computer associated with said purchaser and an identification code to identify the purchaser or the user of the purchaser computer;
means for receiving notification of successful verification of said purchaser computer network address and said identification code by said facilitator computer;
means for selecting goods and/or services offered by way of the vendor computer and sending a request to purchase those goods and/or services;
means for receiving a message from the facilitator computer containing details of said goods and/or services;
means for sending a confirmation message to the facilitator computer confirming willingness to purchase tie goods and/or services from the vendor;
means for receiving die goods and/or services from the vendor; and
means for paying the network access provider for the goods and/or services received from tie vendor as part of an account payment for network access.

19. A system according to claim 18 for use in purchase of services or products, including:
means for receiving a session code from said facilitator computer, the session code signifying successful verification of said purchaser computer network address and said identification code by said facilitator computer;
means for receiving monitoring messages sent by the facilitator computer, and for sending a return response termination message to the facilitator computer;
wherein the payment for the services or products is made in accordance with the length of time of receipt of the services or products as determined by the facilitator computer.

20. A system according to claim 19, including means to display, in response to said monitoring messages, time metering information, and means for enabling the purchaser to selectively send a termination message to the facilitator computer.

21. A system according to claim 19, including means for sending return response messages to the facilitator computer in response to receipt of said monitoring messages, to enable determination by the facilitator computer as to a network connection status of the purchaser computer, in order to determine service or product provision duration.
